(19) United States
(12) Patent Application Publication
(10) Pub. No.: US 2017/0345050 A1
(43) Pub. Date: Nov. 30, 2017

(54) ATTRIBUTION SYSTEM AND METHOD

(71) Applicant: Trever Gregory, Newport Beach, CA (US)

(72) Inventor: Trever Gregory, Newport Beach, CA (US)

(21) Appl. No.: 15/604,304

(22) Filed: May 24, 2017

Related U.S. Application Data
(60) Provisional application No. 62/340,968, filed on May 24, 2016.

(51) Int. Cl. G06Q 30/02; G06F 17/30

(52) U.S. Cl. CPC G06Q 30/0246; G06Q 30/0277; G06F 17/3002; G06F 17/30044; G06Q 30/0251

(57) ABSTRACT

Described herein are systems and methods for associating consumer-perceived broadcasted content with consumer actions. In some embodiments, a computer-based memory communicatively coupled to a processor has computer executable instructions stored therein capable of implementing various components, including a definition component configured to define one or more targeted content features, such as a specific television commercial. These embodiments can further comprise a recognition component configured to recognize when the targeted content features are broadcast through a media device in a particular household and an airing database component configured to store airing information regarding the broadcast. In some embodiments, Automatic Content Recognition is utilized, allowing offline consumer perception of an advertisement to be attributed to online activity of a consumer. In some embodiments, the airing information can be associated with an internet protocol (IP) address and can be correlated to a corresponding IP address associated with online consumer action.

### CROSS REFERENCE TO RELATED APPLICATIONS

This application claims the benefit of U.S. Provisional Application Ser. No. 62/340,968 to Trever Gregory, entitled IP ADDRESS ACR SYSTEM AND PROCESS, filed on May 24, 2016. This application is hereby incorporated herein in its entirety by reference.

### BACKGROUND OF THE INVENTION

### Field of the Invention

Described herein are systems and methods relating to the accumulation of data concerning content recognition of perceived content such as an advertisement on television, radio or the internet, for example, Automatic Content Recognition (ACR) of the perceived content, and association of this data with data concerning actions of individuals viewing the content, for example, internet search data or online purchases.

### Description of the Related Art

In modern times, one of the largest businesses involves the generation of business itself in the form of outreach to potential consumers in the form of media, marketing and advertising. Paramount the pursuit of potential consumers and their feedback to particular marketing strategies, such as an advertisement or product placement in a viewed television program, being particularly valuable.

Some media agencies have attempted to solve the issue of gathering viewership response feedback data from perceived advertisements to a certain extent by utilizing “viewer spike attribution” models to correlate “incremental lift” of typical television-driven digital actions, for example, storing data regarding website searches conducted by consumers on an advertiser's website on their own internal servers during the time a certain television advertisement airs. One issue with this proposed solution is that it is not possible to specifically correlate particular consumer responses to perceiving of an advertisement. For example, if an advertiser's website achieved two-hundred and fifty “hits” during the running of a television advertisement, and if two-hundred visitors of the two-hundred and fifty visitors were determined to be due to “incremental lift,” it is not possible to know which of the specific two-hundred visitors were incremental visitors and which were visiting independently of perceiving the advertisement.

### SUMMARY OF THE INVENTION

Embodiments incorporating features of the present invention include systems and methods to correlate data between a person's actions and/or location, typically through association with a specific Internet Protocol (IP) address, and that person's perceiving of content, for example, a program or advertisement on television, internet and/or radio. Systems and methods incorporating features of the present invention allow for a consumer's offline viewership activity, for example, watching television or listening to the radio, to be attributed to the consumer's online actions, such as visiting the website of the company of the advertisement the consumer just viewed or conducting an internet search for the product the consumer just heard on a radio advertisement. In some embodiments, automatic content recognition (ACR) can be utilized to obtain data regarding the consumer perceiving targeted content, such as an advertisement.

In one embodiment, a system for associating consumer actions with consumer-perceived broadcasted content comprises a memory communicatively coupled to a processor, the memory having stored therein computer executable instructions configured to implement one or more components of the system, including: 1) a definition component configured to define one or more targeted content features; 2) a recognition component configured to recognize when the one or more targeted content features are broadcast through a media device; and 3) an airing database component configured to store airing information when the recognition component recognizes the one or more targeted content features broadcast through the media device.

In another embodiment, a system for associating consumer actions with consumer-perceived broadcasted content, comprising: a memory communicatively coupled to a processor, the memory having stored therein computer executable instructions configured to implement one or more components of the system, including: 1) a definition component configured to define one or more targeted content features; 2) a recognition component configured to recognize when the one or more targeted content features are broadcast through a media device; and 3) an airing database component configured to store airing information when the recognition component recognizes the one or more targeted content features broadcast through the media device. The embodiment further comprises a consumer action database configured to store information regarding online consumer action taken during and after the recognition component recognizes when the one or more targeted content features are broadcast through the media device, and an attribution component configured to correlate the airing information with the online consumer action.

In yet another embodiment, a method for associating consumer actions with consumer-perceived broadcasted content, comprising: defining one or more targeted content features; configuring a memory communicatively coupled to a processor, the memory having stored therein computer executable instructions configured to: 1) recognize when the one or more targeted content features are broadcast through a media device; and 2) store airing information when it is recognized that the one or more targeted content features are broadcast through the media device, the airing information comprising the date and time the one or more targeted content features were broadcast through the device and the IP address of the processor. The method further comprises storing information regarding online consumer action taken after it is recognized that the one or more targeted content features are broadcast through the media device, the airing information comprising the date and time the one or more targeted content features were broadcast through the media device and the IP address of the online consumer action, and correlating the IP address of the processor with the IP address of the consumer action.

These and other further features and advantages of the invention would be apparent to those skilled in the art from the following detailed description, taken together with the accompanying drawings, wherein like numerals designate corresponding parts in the figures, in which:

### BRIEF DESCRIPTION OF THE DRAWINGS

FIG. 1 shows a block-diagram of an embodiment of a demonstrative system incorporating features of the present invention;

FIG. 2 shows a block-diagram of another embodiment of a demonstrative system incorporating features of the present invention;

FIG. 3 shows a block-diagram of yet another embodiment of a demonstrative system incorporating features of the present invention;

FIG. 4 shows a schematic representation of an example environment for the use of embodiments incorporating features of the present invention; and

FIG. 5 shows a flow-chart of an embodiment method incorporating features of the present invention.

### DETAILED DESCRIPTION OF THE INVENTION

The present disclosure will now set forth detailed descriptions of various embodiments. These embodiments comprise systems and methods for associating consumer actions, such as internet activity, with consumer-perceived broadcasted content, such as a consumer-perceived commercial on television, online, or on the radio.

In some embodiments of systems and methods incorporating features of the present invention, at least two sets of data are obtained: 1) Airing data pertaining to specific content that a consumer perceives, for example, that a media device was broadcasting a specific advertisement at a specific time to a location with a specific IP address; and 2) Consumer-action data pertaining to actions taken by the consumer during and after the time the specific content was being broadcast through the media device, for example, internet searches performed by the consumer.

Systems and methods incorporating features of the present invention can utilize computing devices, for example, computers (such as large-scale commercial computers and servers or personal computers), hand-held computing devices (such as smart phones, laptops, computing tablets or personal digital assistants), or any other computing device comprising memory communicatively coupled to a processor having stored therein computer executable instructions according to the present invention. Since computing devices and their processing and memory capabilities are known technology, they are only briefly described herein. Computing devices operable to execute stored instructions and components of systems and methods incorporating features of the present invention can include a processor, for example, a processing unit including a single processor, dual microprocessors, or other multiprocessor architectures.

Computing devices operable to execute embodiments incorporating features of the present invention can include system memory, which can include both volatile and nonvolatile memory. A basic input/output system (BIOS), containing the basic routines to transfer information between elements within the computing device, such as during start-up, can be stored in the nonvolatile memory. Nonvolatile memory can include, but is not limited to: ROM, PROM, EPROM, EEPROM, flash memory or any other known form of nonvolatile memory. Volatile memory can include RAM, which acts as external cache memory. RAM is available in many forms, for example, SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computing devices operable to execute embodiments incorporating features of the present invention can also include a system bus, which is configured to couple system components, for example, the system memory and the processor. The system bus can be any of several types of bus structure(s) including a memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

Computing devices operable to execute embodiments incorporating features of the present invention can also include the capability to connect to the internet, for example, to allow communication between the computing device and one or more servers to store information and/or to access a database containing correlated data of targeted content, which is discussed in more detail further herein.

In some embodiments of systems and methods incorporating features of the present invention, automatic content recognition (ACR) can be utilized to determine when specific content is broadcast through or played by a media device. ACR is a known technology and is only briefly described herein. ACR is an identification technology to recognize content played on a media device or present in a media file. Typical ACR devices function by beginning the recognition process by recording an audio clip and sending it to an identification service, which utilizes fingerprinting algorithms to match the recorded audio to corresponding information in a database. The corresponding information is typically associated with metadata. The recognition technology can be implemented via any known technology, for example, acoustic of video fingerprinting or watermarking.

An example of the ACR in use would be the Shazam® application, which can record a short audio clip of a particular song and process the recorded clip through an algorithm, for example, by sending it to an identification service. The recording is then matched by the algorithm to a corresponding information file, which is associated with metadata, such as the name of the song and the performing artist, which is sent back to the user.

Throughout this description, the preferred embodiment and examples illustrated should be considered as exemplars, rather than as limitations on the present invention. As used herein, the term “invention,” “system,” “method,” “present invention,” “present system” or “present method” refers to any one of the embodiments of the invention described herein, and any equivalents. Furthermore, reference to various feature(s) of the “invention,” “system,” “method,” “present invention,” “present system” or “present method” throughout this document does not mean that all claimed embodiments or methods must include the referenced feature(s).

As utilized herein, terms “component,” “interface,” and the like are intended to refer to a computer-related entity, hardware, software (for example, software in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” and “comprising,” when used herein, specify the presence of stated features, integers, steps, operations, elements, and/or components, but do not preclude the presence or addition of one or more other features, integers, steps, operations, elements, components, and/or groups thereof.

The term “consumer” will be used herein to denote an individual or group of individuals who are perceiving the targeted content. The term “consumer” is used for expediency purposes in the disclosure of embodiments incorporating features of the present invention as one primary use for such systems and methods is in advertising, wherein the targeted demographic is often referred to as a consumer. However, no limitations as to the term consumer that could not also be attributed to the term “individual” shall be read into the term “consumer.”

The term “media device” includes any device capable of playing media, such as video and audio content, through it. As a non-exhaustive list, media devices can include televisions, radios, hand-held devices such as smartphones and tablets and computers.

Although the term “broadcast” is traditionally associated with the transmission of content, such as an advertisement or program, through radio or television, it is understood that the term “broadcast” as used herein is intended to “keep the pace” with modern technology. Accordingly, the term “broadcast” as used herein includes any transmission of media, including audio or visual media, through a media device. Accordingly, the non-exhaustive list of the following transmissions can be said to be “broadcast” through a media device: television programs and adds, radio programs and ads, podcast programs and ads, and all internet streaming programs and adds, including internet services such as Netflix® and Hulu®.

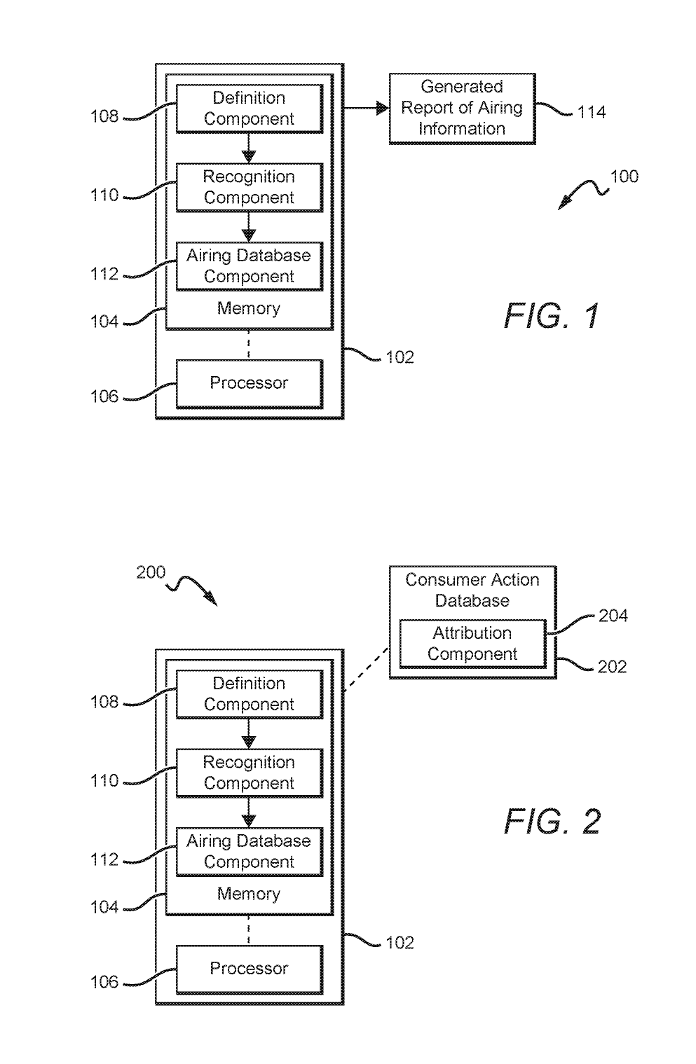

Embodiments of systems and methods incorporating features of the present invention are now described in more detail. FIG. 1 shows a system 100 for associating consumer actions with consumer-perceived content. The system 100 can comprise a consumer-perception attribution portion 102, which can comprise a memory 104 communicatively coupled to a processor 106. The memory 104 can have computer executable instructions, for example stored software, configured to implement one or more components of the system 100. In the embodiment shown, the computer executable instructions are configured to implement a definition component 108, a recognition component 110 and an airing database component 112.

The consumer-perception attribution portion 102 of the system 100, including its memory 104, processor 106 and the stored instruction for implementing the definition component 108, the recognition component 110 and the airing database component 112, can be integrated directly into a media device to be monitored, for example, the consumer-perception attribution portion 102 can be within a smart television capable of running applications. Alternatively or additionally, the consumer attribution portion 102 can be integrated into a separate device from the media device to be monitored, for example, into a separate media device such as a smart phone or a digital assistant device such as an Echo® device or an Alexa® device sold by the company Amazon®. In embodiments wherein the consumer attribution portion is incorporated into another device, the other device can comprise features allowing the device to perceive broadcasted content from nearby media devices, for example, audio listening/recording components as is discussed further herein.

Regardless of whether the consumer-perception attribution portion 102 of system 100 is integrated into a media device to be monitored or a separate device, the memory 104 has stored instructions to implement a definition component 108. The definition component 108 is configured to define one or more targeted content features that the system 100 is configured to detect and be communicatively coupled with the recognition component 110 so that the recognition component 110 is configured to recognize the defined targeted content features. The definition component 108 can store definition information, for example, information or files such as audio or video files corresponding to targeted content features in the memory 104 of the system 100 or in another local memory integrated into the consumer-perception attribution portion 102. Alternatively or in addition, the definition component 108 can be configured to communicate with another computing device or memory storage device, for example, another computer or a server. In these embodiments, definition information is not stored locally in the memory 104, but is instead stored remotely on another computing or memory device. In these embodiments, the definition component can be configure to utilize a remote database of definitions when the recognition component 110 perceives content. In some embodiments, the definition component can communicate with another device, for example, via an online connection, to allow the targeted content feature definitions to be updated.

Targeted content can include any content that is desired to be monitored, typically an advertisement or product placement during a television or radio program or movie. The definition component 108 can utilize stored files (either locally or remotely as discussed above) corresponding to the targeted content, for example, stored audio or visual file information which corresponds to audio or visual information of a particular television commercial that can be utilized with ACR. Alternatively or additionally, the definition component 108 can utilize stored information relating to metadata associated with a particular target content, for example, metadata associated with the particular television commercial above. In some embodiments, for example, in embodiments when the consumer-perception attribution portion 102 of system 100 is integrated into a media device to be monitored, for example, a smart television, the definition component 108 can define the targeted content feature of a commercial via associated metadata, such as the targeted feature's title, which can be detected by the recognition component 110 when the commercial is broadcast through the smart television.

Once the targeted content features to be monitored are defined by the definition component 108, they can be integrated with the recognition component 110, which can be communicatively coupled to the definition component. The recognition component 110 can recognize when the targeted content features are broadcast through a nearby or connected media device. The recognition component 110 can comprise any known feature for perceiving the broadcasted content from a media device and recognizing when the targeted content features defined by the definition component 108 are broadcasted through the media device. In some embodiments, the recognition component 110 is communicatively coupled to a microphone, camera, video camera or other recording device in order to perceive broadcasted content. In some embodiments, the recognition component 110 is integrated into the media device itself and is configured to recognize when a particular targeted content feature is broadcast through the media device, for example, by detecting metadata associated with the targeted content feature and checking this metadata against metadata defined by the definition component.

In some embodiments, the recognition component 110 comprises automatic content recognition features. In these embodiments, the definition component 108 is configured to define one or more audio or visual files corresponding to at least a portion of a corresponding audio or visual data of a targeted content feature, such as a commercial. When the recognition component 110 perceives the commercial, it utilizes an ACR algorithm to determine that the targeted content was broadcast through the media device, for example, by utilizing fingerprinting or watermarking technologies. Once the recognition component 110 has recognized that the targeted content features were broadcast through the media device, associated airing information can be stored by the airing database component 112, which can store the airing information either locally or remotely as will be discussed further herein.

The airing information can include any relevant information associated with the airing of the targeted content feature. As a non-exhaustive list of examples, the airing information can include the date and/or time the targeted content feature was broadcast through the media device and the length of the broadcast (for example, was the whole commercial broadcast or was the channel changed). One particularly valuable piece of airing information that can be stored by the airing database component 112 is the IP address of the location where the broadcast occurred. For example, the consumer-perception attribution portion 102 of system 100, including its memory 104 and processor 106 can be connected to the internet and have an associated IP address, which corresponds to the consumer's household. Even when the consumer is engaged in “offline” viewing activity, for example, watching television not otherwise connected to the internet or listening to terrestrial radio, the airing database component 112 of the online system 100 can store data relating not only to the broadcast of the targeted content features, but that the features were watched (or at least broadcast through a media device) at a particular IP address. The airing database component 112 can also associate its connected IP address with the broadcast information. This configuration allows for a user's “offline” activity to be attributed to an online IP address.

The airing database component 112 can store the airing information (either locally or remotely, for example on a server) for later use, or can transmit the stored data to a separate service for immediate association with additional data or recordation for distribution. In some embodiments, the system 100 is configured to generate a report 114 of the airing information.

This report 114 can be utilized for further analysis. One example of analysis that the airing data can be used for includes utilizing this data in conjunction with data obtained from an advertiser's website. For example, a sales company has a home website which has information about their products, or possibly even “add to cart” order capability wherein consumers can order products directly from the website. This sales company has existing data statistics of consumer action, for example, a list of IP addresses that generated “hits” on their home website. By correlating the IP addresses visiting the home website with the time of airing of an advertisement on television, the sales company can attempt to figure out increased traffic due to advertisement. However, the sales company would not be able to directly attribute the advertisements effectiveness to increased traffic, as some of the hits during the time period in question could be incidental. With the airing data of system 100, the IP addresses of consumer households where the advertisement actually aired can be cross-referenced with the IP addresses from the sales company's consumer action data to find out exactly which hits came from households where the add aired.

While it is clear from the above that simply generating the airing data complete with IP addresses is in itself useful, particularly when coupled with existing website statistics, further embodiments incorporating features of the present invention incorporate additional elements. FIG. 2 shows a system 200, similar to the system 100 above, where like reference numbers are utilized to denote like features. Like in the system 100 above, the system 200 comprises a consumer-perception attribution portion 102, which can comprise a memory 104 communicatively coupled to a processor 106. The memory 104 can have computer executable instructions configured to implement one or more components of the system 200. In the embodiment shown, the computer executable instructions are configured to implement a definition component 108, a recognition component 110 and an airing database component 112.

Unlike the system 100 in FIG. 1, the system 200 in FIG. 2 further comprises a consumer action database 202, which can comprise an attribution component 204. The consumer-perception attribution portion 102 of the system 200 is configured to communicate with the consumer action database 202, which can be integrated into the consumer-perception attribution portion 102 of the system 200, or can be remote from the consumer-perception attribution portion 102 as shown in FIG. 2. The consumer action database 202 can comprise a computing or memory storage device (such as a server) and store data in memory relating to consumer actions, for example, online consumer actions.

In some embodiment's, the consumer action database 202 is managed by a company that has gathered consumer action data, for example, a sales company with an online presence. The company can obtain this information via website hits and website searches with certain IP addresses, and in the consumer action database 202. The sales company can then communicatively link the consumer action database 202 with the consumer-perception attribution portion 102, for example, though an internet connection. In some embodiments, the consumer action database 202 can comprise a central data server managed by a third party, to which a company can provide their website traffic data as will be discussed further herein.

If the company managing the consumer action database 202 has data relating to website traffic of certain IP addresses at a time a certain advertisement is run, and if the definition component 108 is configured to detect when this ad is broadcast through a media device and store the airing information of the broadcast (including IP address of the household perceiving the broadcast) via the airing information component 112, the consumer-perception attribution portion 102 of the system 200 can communicate with the consumer action database 202 to provide the airing data information to the consumer action database 202, which already possesses the consumer action data.

In addition to or in lieu of a “manual” attribution of data by checking both generated data sets against each other, an attribution component 204 can be configured to correlate the two sets of data. The attribution component 204 can be configured with memory communicatively coupled to a processor, having stored therein computer executable instructions configured to implement the attribution component 204. The attribution component 204 can utilize algorithms to match data from the airing data set with data from the consumer-action data set, for example, to match corresponding IP addresses from the airing data with IP addresses of consumer actions taken during the airing of the targeted content. This can tell an individual, for example, which consumers visiting a company's website also viewed the company's broadcast advertisement.

The attribution component 204 can be configured to “learn” and generate more advanced reports based upon repeated use. For example, the attribution component 204 can generate binary response data regarding both consumer action responses to viewed target content features and non-responses. When airing data is transferred to the consumer action database 202 or otherwise utilized, if there is no corresponding consumer action, for example, if a consumer viewed an advertisement but did not then search the company's website, this non-response data can also be utilized to determine an advertisement's effectiveness. Furthermore, additional variables can also be determined, such as increased website sign up data or revenue attributed to a viewed advertisement.

Although FIG. 2 shows the attribution component 204 being communicably integrated with the consumer action database 202, it can be instead communicably integrated with the consumer-perception attribution portion 102 or with a separate computer to allow for both sets of data (airing data and consumer action data) to be utilized by the attribution component 204.

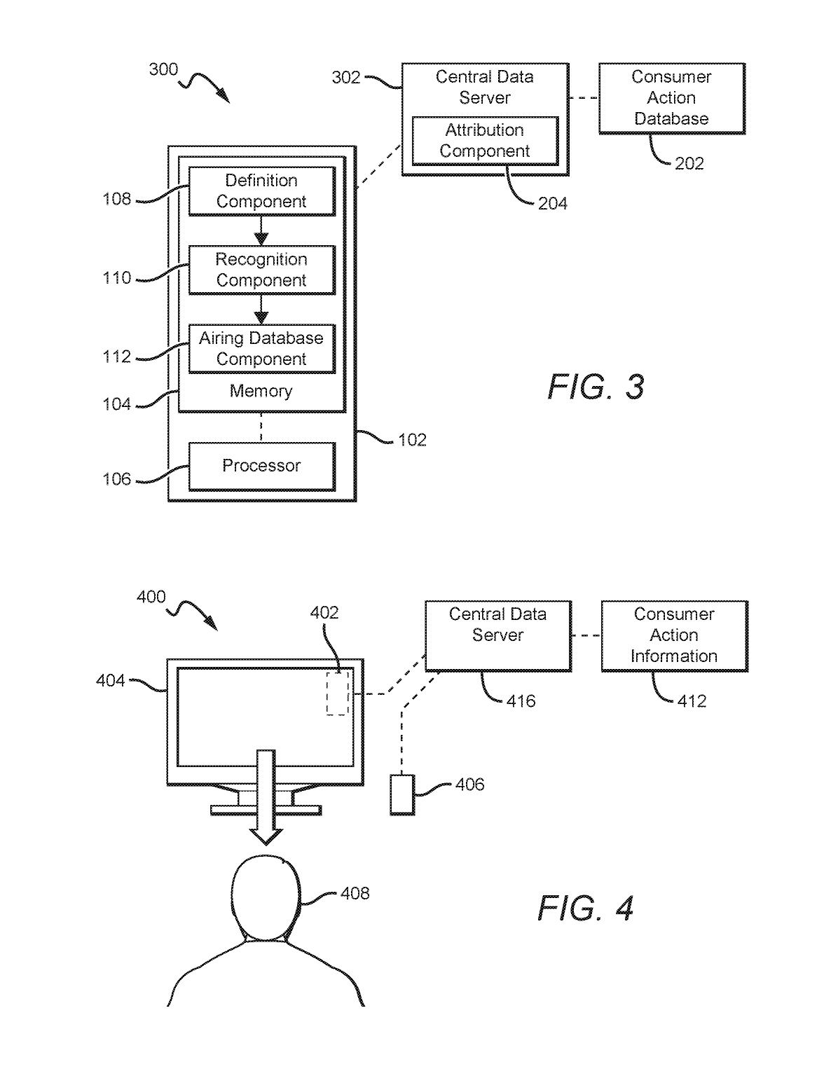

FIG. 3 shows an example embodiment wherein the attribution and storage of data is conducted by a separate central data server. FIG. 3 shows a system 300, similar to the system 200 above, where like reference numbers are utilized to denote like features. Like in the system 200 above, the system 300 comprises a consumer-perception attribution portion 102, which can comprise a memory 104 communicatively coupled to a processor 106. The memory 104 can have computer executable instructions configured to implement one or more components of the system 300. In the embodiment shown, the computer executable instructions are configured to implement a definition component 108, a recognition component 110 and an airing database component 112. The system 300 in FIG. 3 also comprises a consumer action database 202.

Unlike the system 200 in FIG. 2, the system 300 in FIG. 3 further comprises a central data server 302 and the attribution component 204 is communicatively coupled with the central data server 302. The system 300 in FIG. 3 is particularly useful in using systems and methods incorporating features of the present invention to offer attribution data services. In these embodiments, a third-party service provider can manage the central data server 302 and can receive airing data from the consumer-perception attribution portion 102, which is located in a consumer household. A company desiring the airing data can hire the services of the service provider and provide the service provider with the particular targeted content feature to track and/or consumer action data for the time of the targeted content's broadcast.

The definition component 108 of the consumer-perception attribution portion 102 can communicate with the central data server 302 to update the definitions for corresponding targeted content so that the recognition component 110 can recognize the content and the airing database component 112 can store airing information regarding the targeted content and transmit the data back to the central data server 302. For example, a sales company can provide data relating to one of its new television advertisements and provide it to the third party company managing the central data server. The central data server 302 can then communicate with the consumer-perception attribution portion 102 and provide computer executable instructions to the definition component 108 to update the definitions of target content features to be recognized by the recognition component 110. Computing devices in communication with the central data server 302 can then execute the attribution component 204 to correlate the airing data with the consumer action data.

The system 300 of FIG. 3 allows for a third party to act as a gatekeeper of the airing information and the consumer action information as a further step to control which parties have access to the information. For example, a sales company managing the consumer action database 202 would not have direct control over a computer communicating with the consumer-perception attribution portion 102 of the system 300.

An example environment 400 of an implementation of systems and methods is set forth schematically in FIG. 4, which shows a first consumer-perception attribution portion 402 integrated into a media device 404 and a second consumer-perception attribution portion 406, separate from the media device 404. The consumer-perception attribution portions 404, 406 are similar to the consumer-perception attribution portion 102 discussed herein. While two consumer-perception attribution portions 402, 406 are shown, it is understood that either or both can be utilized. When the media device 404 broadcasts targeted content to a user 408, the consumer-perception attribution portions 402, 406 recognize the content and communicate airing data, including IP address information to a central data server 410, similar to the central data server 302 discussed with regard to FIG. 3.

A company with consumer action information 412 including website hits during or shortly after airing of the broadcasted targeted content, and corresponding IP addresses, can provide the information to the central data server 410. Individuals with access to the central data server 410 now have access to both sets of information and can attribute airing information to consumer action information, either through “manual” analysis of reports or through use of an attribution component as described herein.

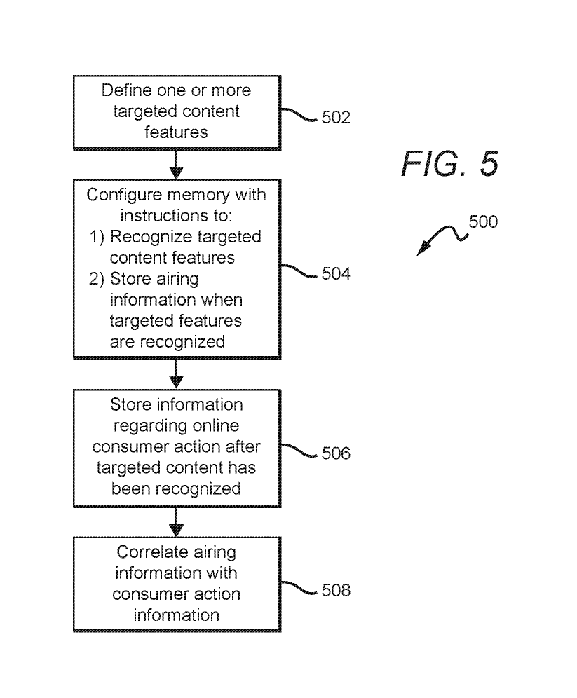

An example method 500 incorporating features of the present invention is set forth in FIG. 5. In a first step 502, one or more targeted content features are defined. In a second step 504, memory communicatively coupled with a processor is configured to have computer executable instructions stored therein to recognize when one or more targeted content features are broadcast through a media device and to store airing information when it is recognized that the one or more targeted content features are broadcast through the media device. In a third step 506, information regarding online consumer action after recognition of the targeted content is stored. In a further step 508, the airing information is correlated with the consumer action information. If IP addresses are part of the consumer action information and the airing information, the IP address can be correlated to help determine the efficacy of an advertisement as described herein.

It is understood that while the present application largely described consumer action data as relating to online activity, particularly because this data would be readily available to a company via its own website traffic statistics, other forms of consumer action data can be utilized with embodiments incorporating features of the present invention. For example, if data can be collected corresponding to consumers making purchases at a “brick and mortar” store after perceiving an advertisement, this data can be correlated to the airing data just as readily as online traffic data.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

I claim:

1. A system for associating consumer actions with consumer-perceived broadcasted content, comprising:
a memory communicatively coupled to a processor, said memory having stored therein computer executable instructions configured to implement one or more components of said system, including:
a definition component configured to define one or more targeted content features;
a recognition component configured to recognize when said one or more targeted content features are broadcast through a media device; and
an airing database component configured to store airing information when said recognition component recognizes said one or more targeted content features broadcast through said media device.

2. The system of claim 1, wherein said airing information includes information selected from the group consisting of an Internet Protocol (IP) address associated with said processor, the time at which said one or more targeted content features are broadcast through said media device, and the date of which said one or more targeted content features are broadcast through said media device.

3. The system of claim 1, wherein said recognition component comprises automatic content recognition features.

4. The system of claim 1, wherein said processor is integrated into said media device.

5. The system of claim 1, wherein said processor is separate from said media device.

6. The system of claim 3, wherein said processor is separate from said media device.

7. The system of claim 6, wherein said recognition component is configured to perceive visual or sound stimuli from said media device to recognize when said one or more targeted content features are broadcast through said media device.

8. The system of claim 1, wherein said airing database component is configured to generate a report of said airing information when said recognition component recognizes when said one or more targeted content features are broadcast through said media device.

9. The system of claim 8, further comprising a consumer action database configured to store information regarding online consumer action taken after said recognition component recognizes when said one or more targeted content features are broadcast through said media device.

10. The system of claim 9, wherein said consumer action database comprises a database separate from said memory.

11. The system of claim 9, further comprising an attribution component configured to correlate said
airing information with said online consumer action information.

12. The system of claim 10, wherein said airing information includes an IP address associated with said processor and said consumer action information includes an IP address associated with said online consumer action.

13. The system of claim 12, further comprising an attribution component configured to match said IP address associated with said processor and said IP address associated with said online consumer action.

14. A system for associating consumer actions with consumer-perceived broadcasted content, comprising:
a memory communicatively coupled to a processor, said memory having stored therein computer executable instructions configured to implement one or more components of said system, including:
a definition component configured to define one or more targeted content features;
a recognition component configured to recognize when said one or more targeted content features are broadcast through a media device; and
an airing database component configured to store airing information when said recognition component recognizes said one or more targeted content features broadcast through said media device;
a consumer action database configured to store information regarding online consumer action taken during and after said recognition component recognizes when said one or more targeted content features are broadcast through said media device; and
an attribution component configured to correlate said airing information with said online consumer action.

15. The system of claim 14, wherein said recognition component comprises automatic content recognition features.

16. The system of claim 14, wherein said processor is separate from said media device.

17. The system of claim 14, wherein said processor is integrated into said media device.

18. The system of claim 14, wherein said airing information includes an IP address associated with said processor and said consumer action information includes an IP address associated with said online consumer action.

19. The system of claim 18, wherein said attribution component is configured to match said IP address associated with said processor and said IP address associated with said online consumer action.

20. A method for associating consumer actions with consumer-perceived broadcasted content, comprising:
defining one or more targeted content features;
configuring a memory communicatively coupled to a processor, said memory having stored therein computer executable instructions configured to:
recognize when said one or more targeted content features are broadcast through a media device; and
store airing information when it is recognized that said one or more targeted content features are broadcast through said media device, said airing information comprising the date and time said one or more targeted content features were broadcast through the device and the IP address of said processor;
storing information regarding online consumer action taken after it is recognized that said one or more targeted content features are broadcast through said media device, said airing information comprising the date and time said one or more targeted content features were broadcast through said media device and the IP address of said online consumer action; and
correlating the IP address of said processor with the IP address of said consumer action.
